(19) United States
(12) Patent Application Publication
(10) Pub. No.: US 2015/0047574 A1
(43) Pub. Date: Feb. 19, 2015

(54) FOLDABLE SOFT CRATE FOR PET

(71) Applicant: Vermont Juvenile Furniture Mfg., Inc. a/k/a Pet Gearc. Inc., West Rutland, VT (US)

(72) Inventors: Scott S. Jakubowski, Castleton, VT (US); Chris Jakubowski, Rutland Town, VT (US); Todd M. Jakubowski, Rutland, VT (US)

(73) Assignee: Vermont Juvenile Furniture Mfg., Inc. a/k/a Pet Gearc. Inc., West Rutland, VT (US)

(21) Appl. No.: 14/315,739

(22) Filed: Jun. 26, 2014

Related U.S. Application Data
(60) Provisional application No. 61/866,267, filed on Aug. 15, 2013.

(51) Int. Cl. A01K 1/03; A01K 1/02

(52) U.S. Cl. CPC A01K 1/034; A01K 1/0245
USPC 119/499; 29/401.1

(57) ABSTRACT

A foldable soft crate is provided having a frame assembly with a top frame and first and second side frames. Each of the side frames being pivotally connected to a respective opposite end of the top frame. First and second locking corner braces are located between a front side of the top frame and a front side of a respective one of the side frames. A cover that includes at least four flexible side panels and a bottom panel connected to each other surrounds a portion of the frame. The top frame and the two side frames are movable upon release of the first and second locking corner braces from a first, extended position, to a second, collapsed position. Only bottom end portions of the first and second side frames contact the bottom panel.

### INCORPORATION BY REFERENCE

The following documents are incorporated herein by reference as if fully set forth: U.S. Provisional Application No. 61/866,267, filed Aug. 15, 2013.

### FIELD OF INVENTION

This invention relates to the field of storage and transportation of pets.

### BACKGROUND

Crates, cages and other similar apparatus for housing and transporting pets are well-known in the art. These cages and crates are rigid, often comprised of steel bars or hard plastic and therefore, provide a sturdy housing. But they take up a large amount of storage space and are not easy to transport. Further, the rigid steel bars or hard plastic frame may injure the pet if it is thrown against the walls of the crate, for example, during a sudden stop in a vehicle. These rigid bars also may damage objects that they come in contact with such as the interior of an automobile or furniture.

To overcome these problems, the industry developed “soft” pet enclosures comprised of a “soft” material such as canvas or nylon located over a rigid, foldable frame. These known “soft” pet enclosures are foldable for storage by pivoting or folding certain frame members. However, in all of the known “soft” enclosures, the rigid frame defines and supports the top, sides, and bottom of the pet enclosure.

There is a need for a durable soft pet crate that is easily foldable, is capable of becoming more compact than the known soft crates, and that reduces weight and cost.

### SUMMARY

In one aspect, the present invention provides a foldable soft crate comprising a frame assembly with a top frame and first and second side frames. Each of the side frames are pivotally connected to a respective opposite end of the top frame. First and second locking corner braces are located between a top frame and a respective one of the side frames. A cover that includes at least four side panels and a bottom panel that are connected together surrounds at least a portion of the frame. The top frame and the two side frames are movable when the first and second locking corner braces are released from a first, extended position, where the two side frames are spaced apart from one another by a length of the top frame, to a second, collapsed position. In the collapsed position, the locking corner braces are folded and the two side frames are moved into proximity with one another and the top frame. Each of the first and second side frames have bottom end portions that contact the bottom panel.

The present invention also provides a method of using a foldable soft crate. The method includes: providing a foldable soft crate having a frame assembly with a top frame and first and second side frames; each of the side frames are pivotally connected to a respective opposite end of the top frame; a first locking corner brace is located between the top frame and the first side frame; a second locking corner brace is located between the top frame and the second side frame; a cover that includes at least four flexible panels and a bottom panel that are connected together surrounds at least a portion of the frame; and folding the foldable soft crate from a first, extended position, to a second, collapsed position by releasing the first and second locking corner braces and drawing the two side frames towards the top frame.

Further aspects of the invention are described below and in the claims.

### BRIEF DESCRIPTION OF THE DRAWINGS

The foregoing summary, as well as the following detailed description of the preferred embodiments of the invention will be better understood when read in conjunction with the appended drawings. For the purpose of illustrating the invention, there is shown in the drawings embodiments which are presently preferred. It should be understood, however, that the invention is not limited to the precise arrangement shown.

FIG. 1 is a front perspective view of a preferred embodiment of the foldable soft pet crate of the present invention in the expanded position.

FIG. 2 is a front view of the embodiment of the foldable soft pet crate shown in FIG. 1 with the front panel opening open.

FIG. 3 is a left-side view of the embodiment of the foldable soft pet crate shown in FIG. 1 with the left-panel opening open.

FIG. 4 is a top view the embodiment of the foldable soft pet crate shown in FIG. 1 with the top panel opening open.

FIG. 5 is a front perspective view of the embodiment of the foldable soft pet crate shown in FIG. 1 with the front panel opening closed.

FIG. 6 is a left-side view of the embodiment of the foldable soft pet crate shown in FIG. 1 with the left-panel opening closed.

FIG. 7 is a top view of the embodiment of the foldable soft pet crate shown in FIG. 1 with the top panel opening closed.

FIG. 8 is a rear perspective view the embodiment of the foldable soft pet crate shown in FIG. 1.

FIG. 9 is a right-side view of the embodiment of the foldable soft pet crate shown in FIG. 1.

FIG. 10 is a perspective view of the foldable soft pet crate shown in FIG. 1.

FIG. 11 is an internal perspective view looking at the right-side portion of the frame of the foldable soft pet crate shown in FIG. 1.

FIG. 12 is an internal perspective view looking in the front opening of the frame of the foldable soft pet crate shown in FIG. 1 wherein the frame is partially collapsed.

FIG. 13 is a perspective view looking at the front of a first locking brace located on a front side of the top portion of the frame of the foldable soft pet crate shown in FIG. 1.

FIG. 14 is a perspective view looking at the back of a second locking brace connecting the front side of the top portion of the frame to a front side of a first side portion of the frame of the foldable soft pet crate shown in FIG. 1.

FIG. 15 is a top, front perspective view of the foldable soft pet crate shown in FIG. 1 partially collapsed.

FIG. 16 is a top, front perspective view of the foldable soft pet crate shown in FIG. 1 in the collapsed.

FIG. 17 is a rear perspective view of the pet crate of FIG. 1, without the cover, shown fully open.

FIG. 18 is a front perspective view of the pet crate of FIG. 17, without the cover, shown partially collapsed.

FIG. 19 is a front perspective view of the pet crate of FIG. 17, without the cover, shown in the fully collapsed.

### DETAILED DESCRIPTION OF THE PREFERRED EMBODIMENTS

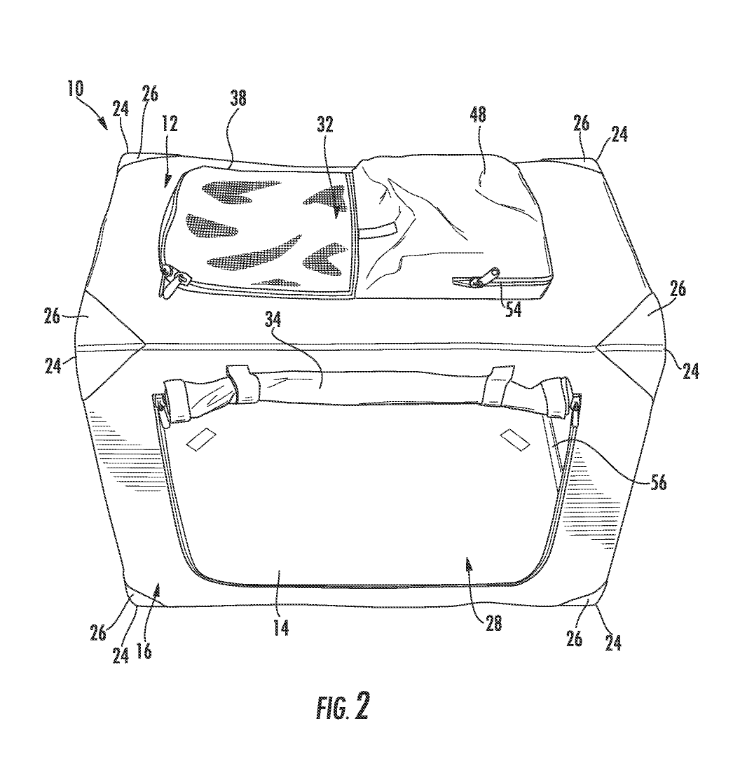

For purposes of this detailed description, words such as “front”, “back”, “top”, “bottom”, “left”, and “right” designate directions based on FIG. 2 of the drawings, and are used for convenience in referring to the designated parts or areas.

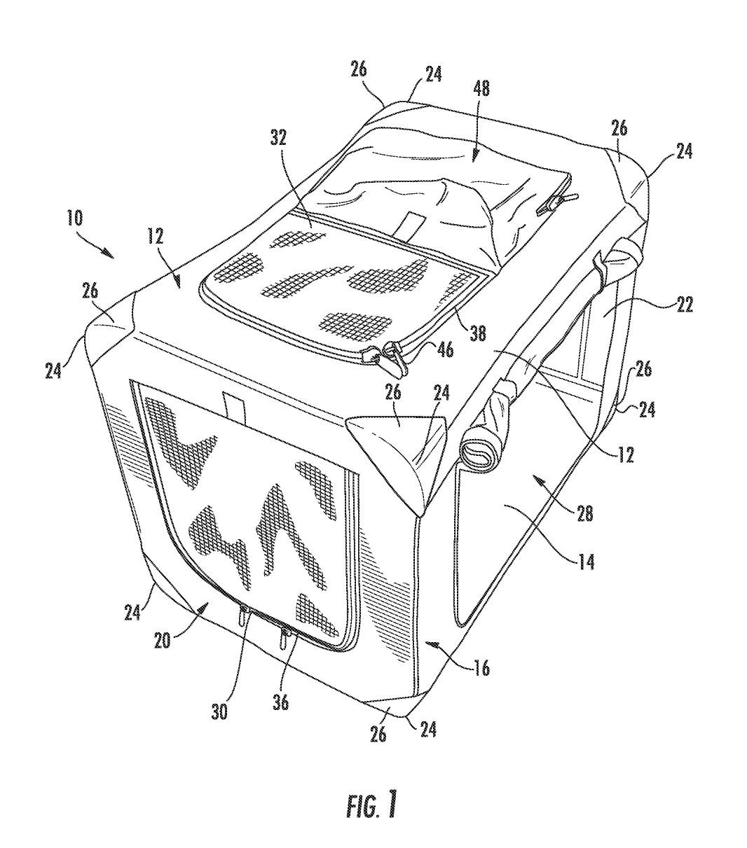

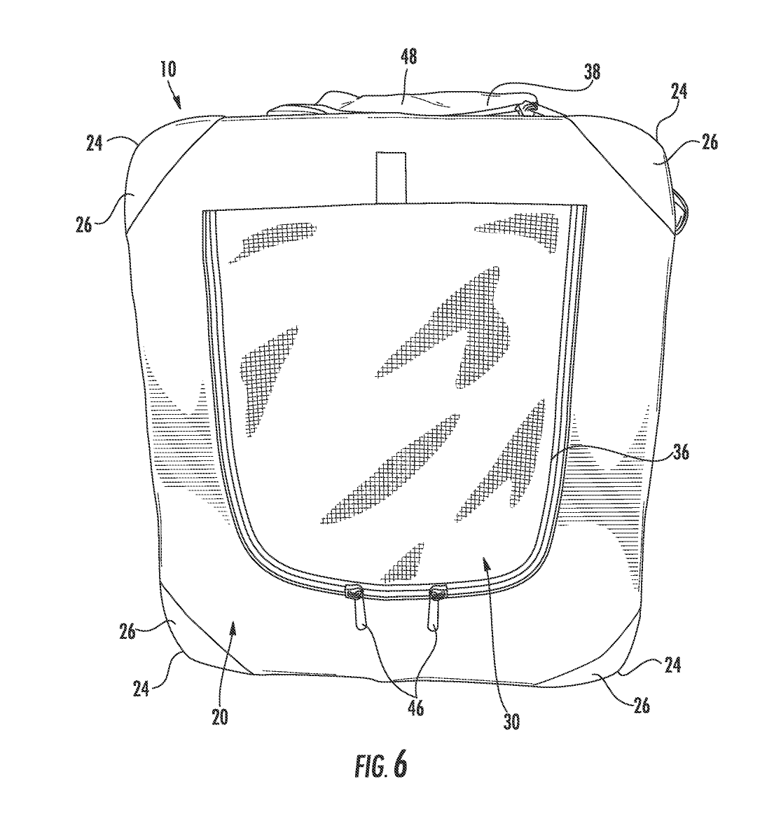

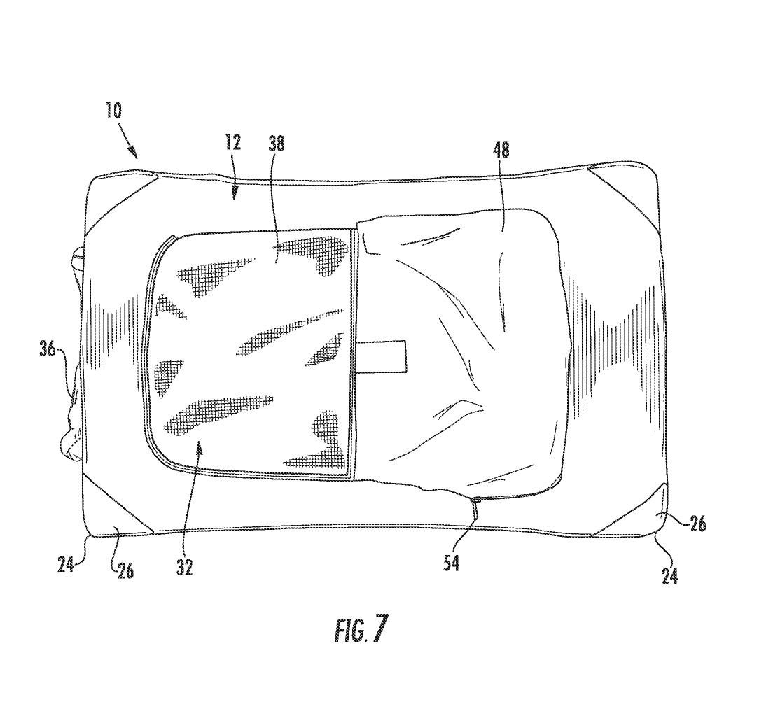

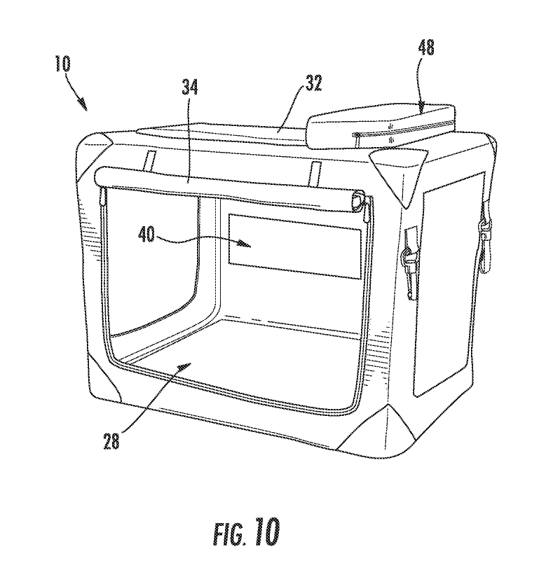

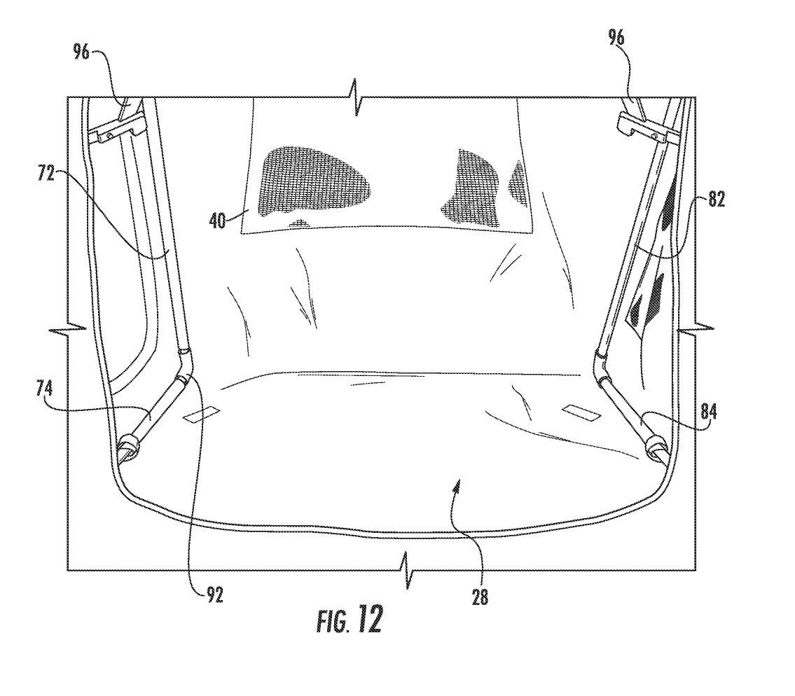

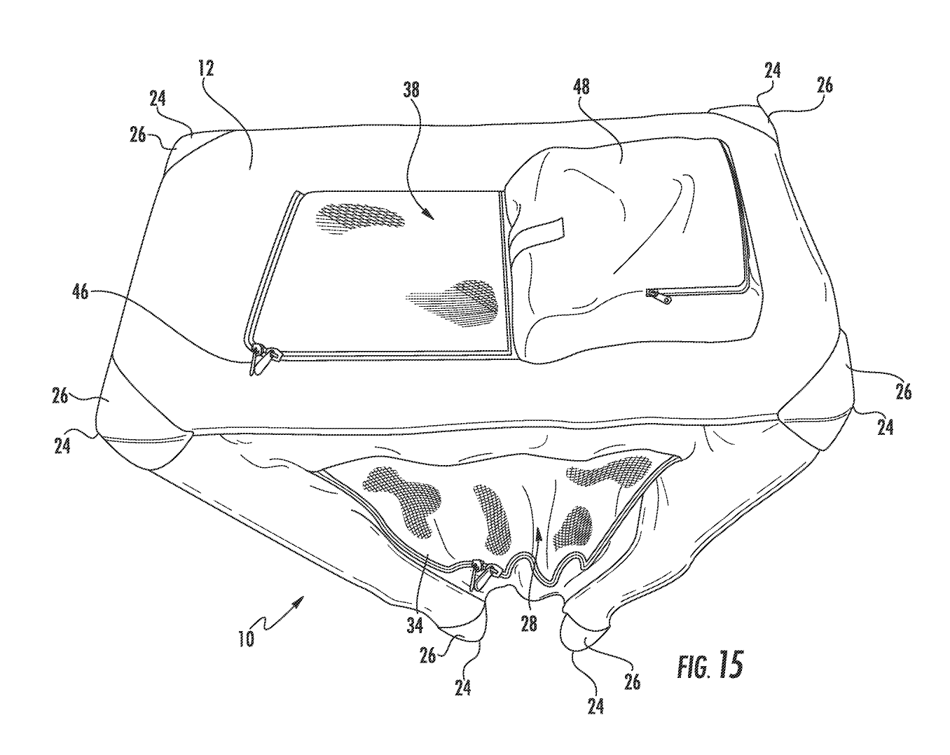

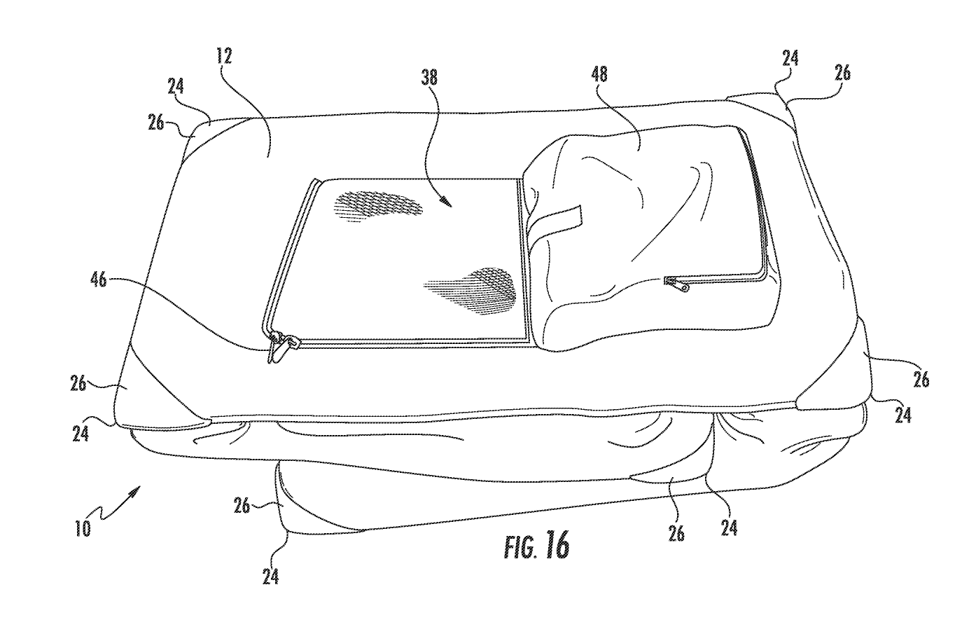

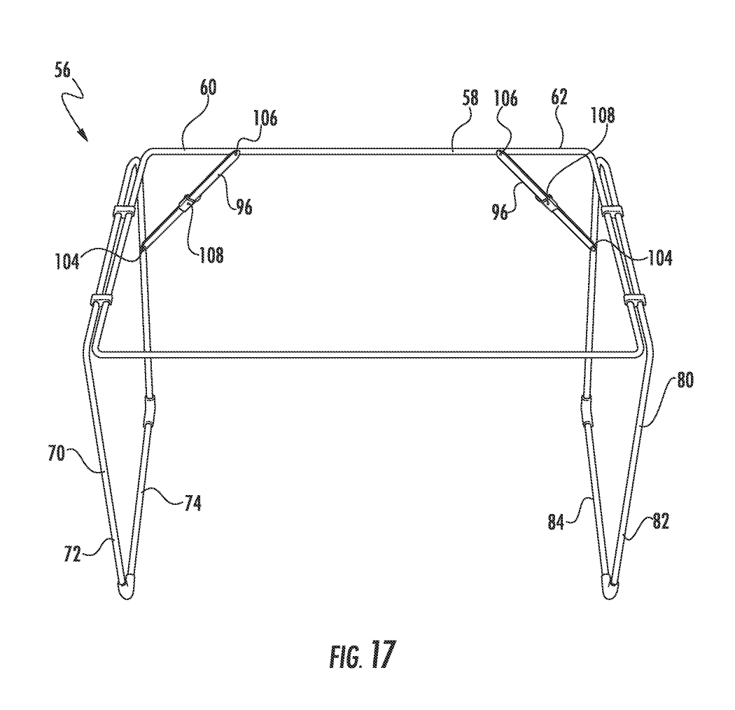

FIGS. 1-19 show a preferred embodiment of the foldable soft pet crate 10 of the present invention. The foldable soft pet crate 10 is generally rectilinear, however, in other embodiments, it can be square, cylindrical or a pyramidal shape. The foldable soft pet crate 10 is comprised of a cover 11 preferably made from six sides or panels, including a top 12, bottom 14, front 16, back 18, a left-side 20 and a right-side 22. Preferably, the panels 12; 14; 16; 18; 20; 22 are comprised of 600 Denier Nylon, but may be comprised of other materials, preferably, soft, breathable, durable, flexible and preferably, machine washable fabrics that cannot be easily damaged by a pet by scratching, chewing, etc. Such materials may include plastic, Cordura®, polyester, canvas, twill, vinyl, leather, cotton, etc. Depending on the pet to be contained, the top panel could be omitted. The panels are connected, preferably by sewing to each other. The cover 11 surrounds and is connected to a rigid, foldable frame, as described in detail below. In another embodiment, there are no separate panels and the cover 11 comprises one piece of soft, flexible material.

As shown in FIG. 1, the corners 24 are preferably rounded and reinforced by corner pads 26. Rounded corners 24 and corner pads 26 reduce the chance that the foldable soft pet crate 10 will damage objects that it comes in contact with such as the interior of an automobile, furniture, etc. The corner pads 26 also keep the corners 24 from fraying and hold the panels more securely together. Preferably, the corner pads 26 are made of a strong fabric that is not likely to damage objects that the foldable soft pet crate 10 comes into contact with. Such fabric may include leather, canvas, twill, etc.

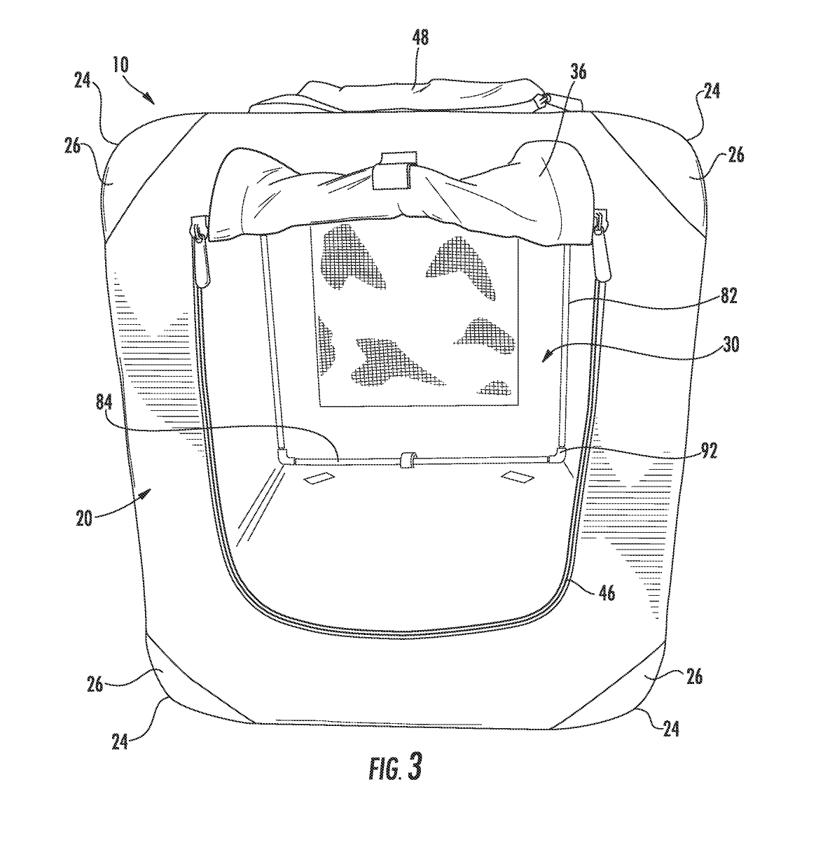

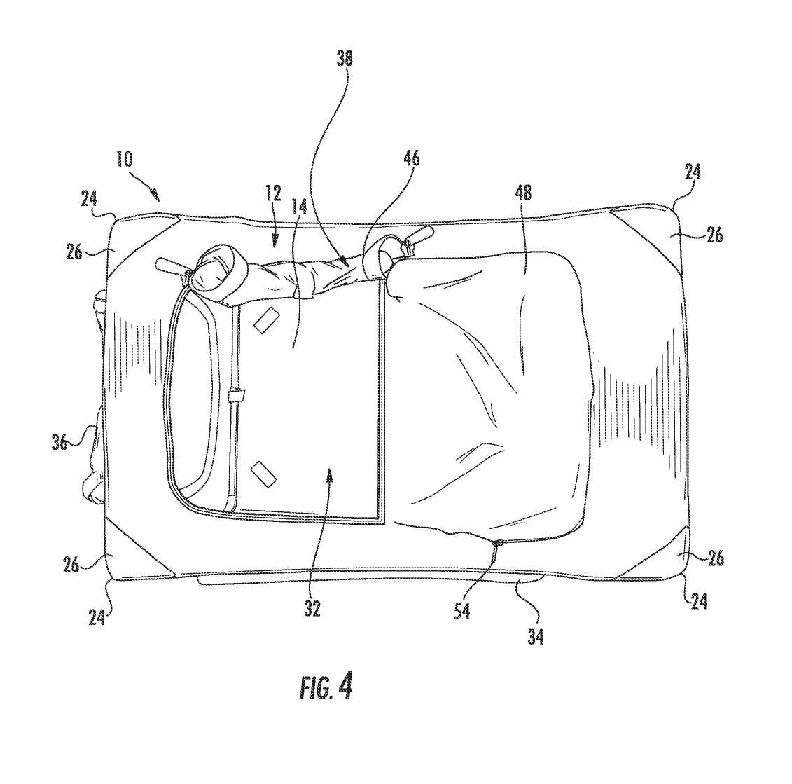

As shown in FIGS. 1 and 2, the front panel 16 has a front opening 28. As shown in FIGS. 1 and 3, the left-side panel 20 has a left-panel opening 30 and, as shown in detail in FIG. 4, the top panel 12 has a top opening 32. In other embodiments, the back 18, bottom 14, and right-side 22 panels may also or alternatively contain openings.

As shown in FIG. 1, the front opening 28 is larger than the left-panel opening 30 and the top opening 32, however, in other embodiments, in particular, where the foldable soft pet crate 10 is not rectangular, the reverse may be true. In other embodiments, the openings 28; 30; 32 are the same size. The front panel opening 28, left panel opening 30 and top panel opening 32 are sized to accommodate at least the largest-sized pet that the particular foldable soft pet crate 10 is designed for. For example, for a “small” sized foldable soft pet crate 10, these openings 28; 30; 32 are large enough to allow at least a thirty-pound pet to pass through. Preferably, the front panel opening 28, top panel opening 32 and left-panel opening 30 each have a zippered edge on at least three sides.

As shown in FIGS. 1-3, flaps 34; 36; 38 are located above the front opening 28, left-panel opening 30, and top opening 32. As shown in FIGS. 1-2, a front opening flap 34 is attached over the front opening 28. As shown in FIG. 3 a left-panel opening flap 36 is attached over the left-panel opening 30. As shown in FIG. 4, a top-opening flap 38 is attached to the top opening 32.

As shown in FIGS. 1-3, the front opening flap 34 and left-panel opening flap 36 can be rolled-up toward the top panel 12 and locked thereon via Velcro® hook and loop textile fastening strips, other clips, buttons, etc. to keep the front opening 28 and left-panel opening 30 opened. As shown in FIG. 4, the top-opening flap 38 can be rolled-up on the back-side of the top opening 32. These flaps 34; 36; 38 may be comprised of soft, breathable, durable, flexible and preferably, machine washable material that cannot be damaged by a pet by scratching, chewing, etc. Such materials may include plastic, Cordura®, polyester, nylon, canvas, twill, vinyl, leather, cotton, etc. In the preferred embodiment, the flaps 34; 36; 38 are comprised of a soft yet durable nylon mesh fabric. Preferably, the flaps 34; 36; 38 are surrounded by zippered edges that surround the openings 28; 30; 32 that the respective flaps 34; 36; 38 are adjacent to.

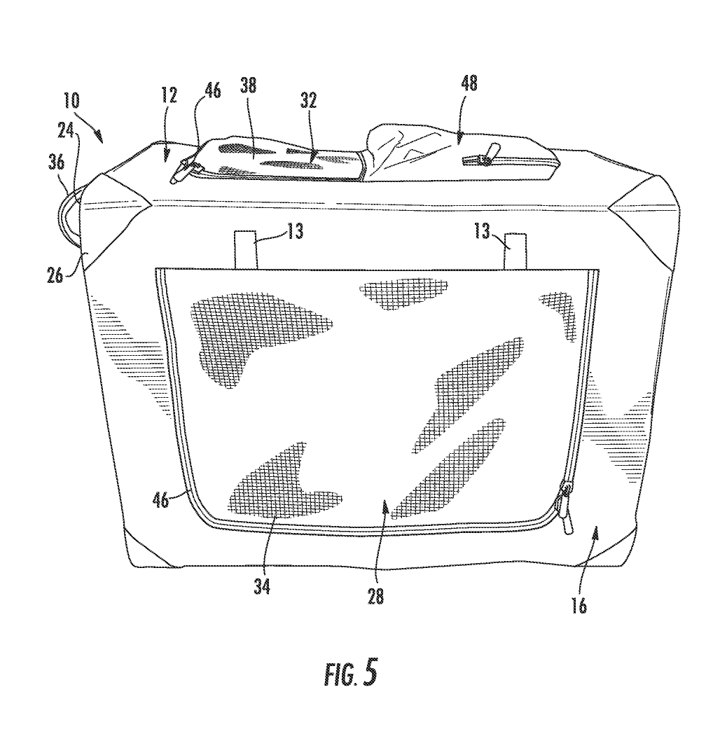

The flaps 34; 36; 38 are sized and shaped to fit within the respective openings 28; 30; 32 that the flaps 34; 36; 38 are adjacent to or above. To close any of the aforementioned openings, the user (not shown) simply unlocks the Velcro® strips, rolls the flaps 34; 36; 38 downward, upward, rightward or leftward depending on the configuration, and secures the flap 34; 36; 38 to its corresponding opening 28; 30; 32 preferably by zippering around the perimeter of the flap with a zipper 46. As shown in FIGS. 5-7, closing the flaps 34; 36; 38 closes the openings 28; 30; 32. One of skill in the art will recognize that other means may be used to secure the flaps 34; 36; 38 to the openings 28; 30; 32 as long as those means do not allow a pet to open the openings. For example, in other embodiments, the flaps may fit over the openings and be secured by Velcro®, clips, buttons, etc. One of skill in the art will recognize that the flaps 34; 36; 38 can be attached to other portions of the foldable soft pet crate 10 or that the flaps 34; 36; 38 can be separate portions attachable to the foldable soft pet crate 10.

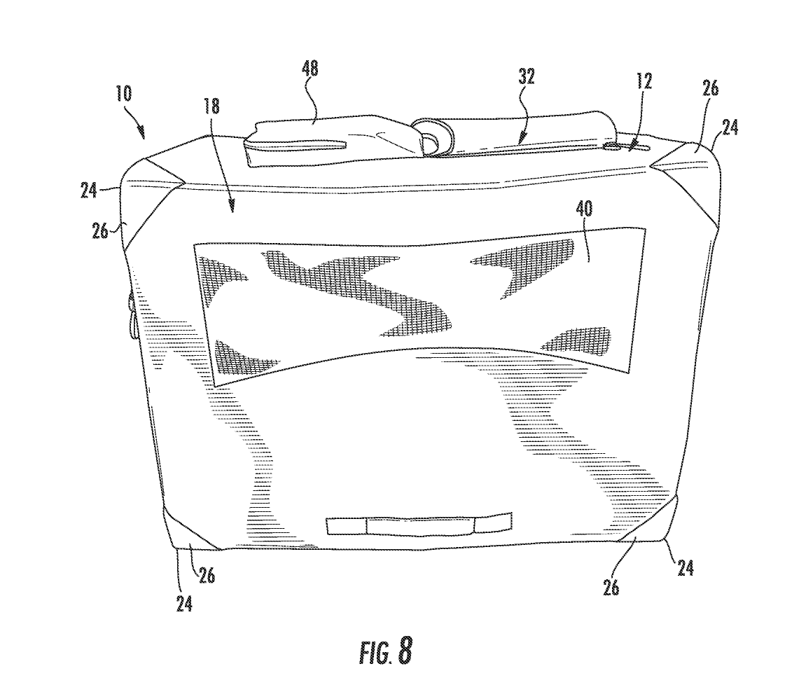

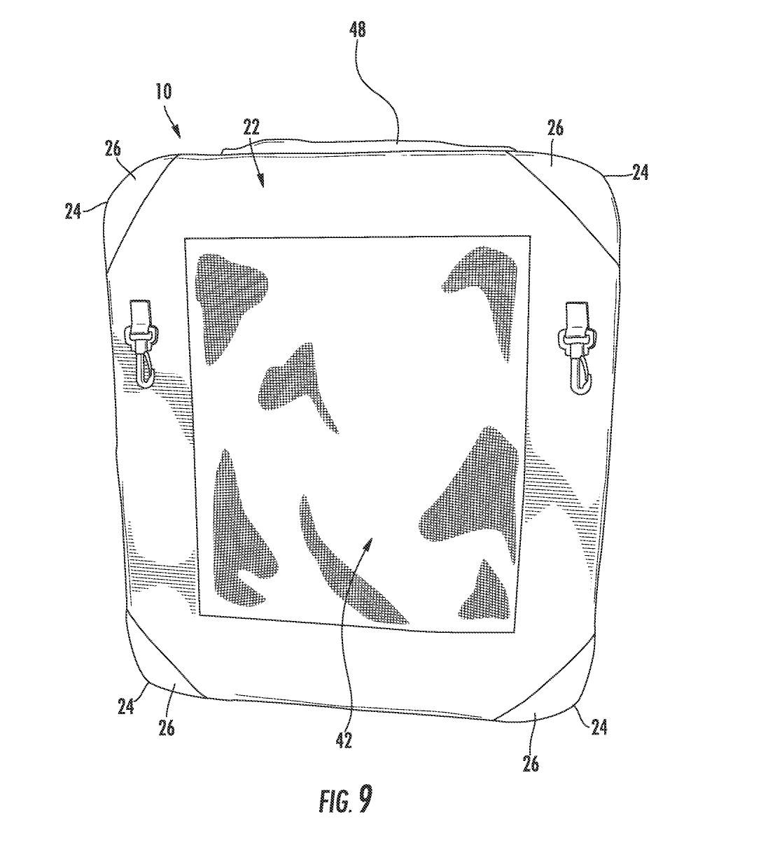

As shown in FIGS. 8 and 9, the back panel 18 and right-side panel 22 have back 40 and side 42 mesh portions. These portions 40; 42 may be comprised of any breathable, durable, flexible and preferably, machine washable material that cannot be damaged by a pet by scratching, chewing, etc. Such materials may include plastic mesh, Cordura®, polyester, nylon, canvas, twill, vinyl, leather, cotton, etc. In the preferred embodiment, the mesh portions 40; 42 are comprised of the same soft, durable nylon mesh fabric as used for the flaps 34; 36; 38. Unlike the mesh opening flaps 34; 36; 38 of the left-side panel opening 30, top opening 32 and front opening 28, mesh portions 40; 42 are preferably sewn into position and are not removable. Mesh portions 40; 42 may be any size or shape that permits air circulation within the foldable soft pet crate 10 and easy viewing of the pet inside. In another embodiment, there are not any mesh portions.

As shown in FIGS. 8 and 9, clips may be used to secure the foldable soft pet crate 10 in place; for example, in a vehicle or to an object in the home. As shown in FIG. 9, squeezable hook clips may be secured to the right-side panel 22. Optionally, clips (not shown) may be attached to one of the panels to allow a user to attach a strap for easy carrying. As shown in FIG. 8, a handle is attached to the back panel 18, which also allows for easy carrying.

As shown in FIGS. 1, 2, 4, and 5, the foldable soft pet crate 10 preferably also has a top storage bag 48. As shown in detail in FIGS. 1 and 4, preferably, the top storage bag 48 is formed as part of the top panel 12. The top storage bag 48 is preferably opened and closed via a zipper 46, and could also be opened and closed using other similar connectors, such as buttons, snaps, or Velcro® textile fastening straps. The top storage bag 48 is sized to accommodate a removable floor mat (not shown) or tray 54, pet food, toys, etc.

As shown in FIGS. 1, 3, 11, 12 and 17-19, the cover of the foldable soft pet crate 10 is supported by a frame assembly 56. In the preferred embodiment, the frame assembly 56 is comprised of a top frame 58, a left-side frame 70 and a right-side frame 80. In other embodiments, the frame assembly 56 may be comprised of more or less portions. In the preferred embodiment, these portions are comprised of steel tubing. But they may be comprised of any durable, strong, rigid material such as plastic.

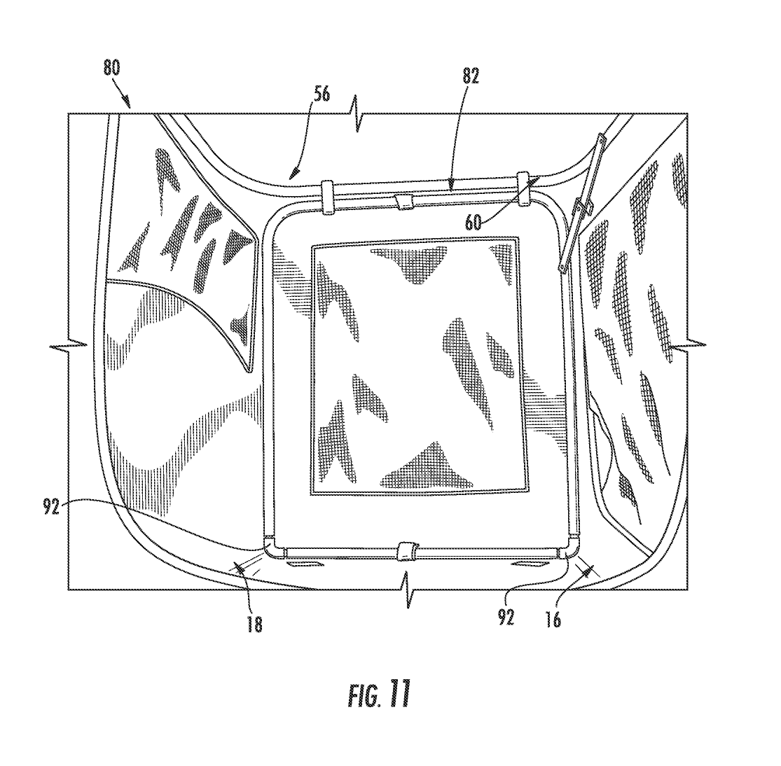

As shown in FIGS. 11, 17, 18 and 19, the top frame 58 is further comprised of a first top member 60 and a second top member 62. In the preferred embodiment, the first top member 60 and the second top member 62 are U-shaped, the first top member 60 being configured to be connected to the second top member 62 so that the resulting top frame 58 is a continuous structure. The two U-shaped members 60; 62, when connected, form a substantially rectilinear top frame 58. One of skill in the art would understand that in other embodiments, the U-shaped members 60; 62 may have another shape or that the top frame 58 can be formed from a single bar bent or otherwise formed into the rectilinear shape.

As shown in FIGS. 11-13, and 17-19 the left-side frame 70 and the right-side frame 80 each have a U-shaped upper member 72; 82 and a base member 74; 84 connected to the U-shaped upper member 72; 82. The base member 74; 84 of each respective side frame 70; 80 forms a bottom end of each respective one of the side frames 70; 80, and the U-shaped upper member 72; 82 is secured to the base member 74; 84 by first and second corner parts 92. These corner parts 92 may include downwardly extending projections or feet so that the base member 72; 84 is spaced up from the bottom panel 14. One of skill in the art would understand that in other embodiments, the left and right-side frames 70; 80 may also be hinged, continuous, or have another shape.

In the preferred embodiment, each of the side frames 70; 80 are pivotally connected to a respective opposite end of the top frame 58 by pivot clamps 90. Each of the pivot clamps 90 is preferably plastic, but may be comprised of any suitable material. Preferably, the pivot clamps 90 are formed of two plastic clips that are connected together about the tube forming an end of the top frame 58, and define a cylindrical opening in which an upper tube member of the side frames 70; 80 are pivotally located.

In the preferred embodiment, the U-shaped upper member 72; 82 of each of the side frames 70; 80 is connected by a respective locking corner brace 96 to the top frame 58 of the frame assembly 56.

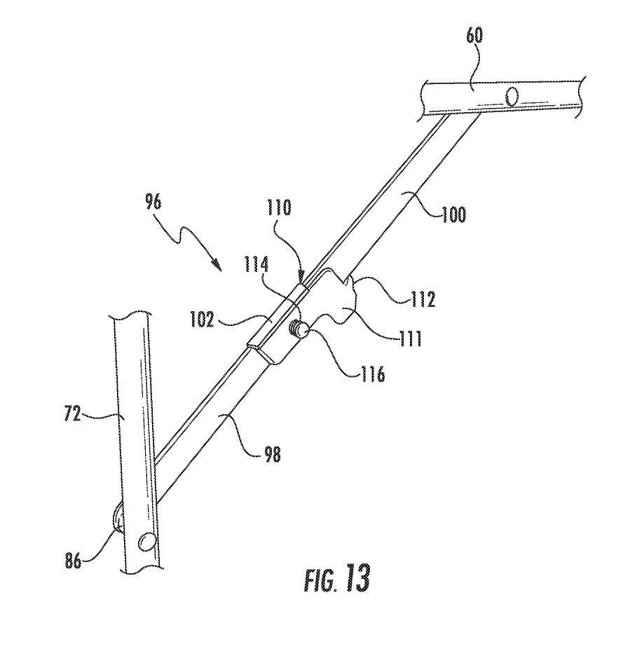

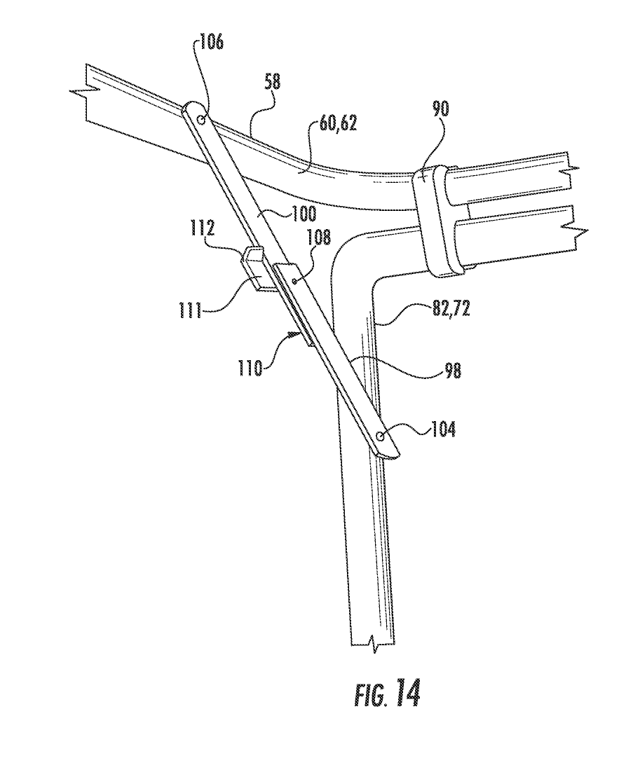

The locking corner braces 96 each have a first link 98 and second link 100 that are rotatable relative to each other about a common pivot point 108. Each of the locking corner braces 96 has a first pivot point 104 on a first end of the first link 98, a second pivot point 106 on a first end of the second link 100, and the common third pivot point 108 is formed by a rivet 116 located at a second end of each of the first and second 98; 100 links, as shown in FIGS. 13 and 14. Preferably, the first ends of the links 98; 100 are connected at the pivot points 104; 106 to the side frames 70; 80 and top frame 58 via fasteners that define pivot axes for pivoting movement of the first and second links 98; 100 relative to the respective frames 56; 70; 80. A spacer 86 can be provided between the links 98; 100 and the frames 56; 70; 80, if desired.

A locking mechanism 110 is located between the first link 98 and second link 100 and locks the links 98; 100 into an extended configuration to secure the frame assembly 56 in the first, extended position. The locking mechanism includes a lock plate 111 having a locking tab 112, shown in FIG. 13, which is integral with the lock plate 111, which releases and secures the locking mechanism 110.

As shown in FIGS. 13, 14, and 17-19, the first link 98 of each of the locking corner braces 96 has at least one catch wall 102 that extends perpendicular to a side surface of the first link 98. The catch wall 102 of the first link 98 abuts an opposite side edge of the second link 100 from the locking tab 112 in the open position, and the locking tab 112 abuts the opposite edge of the second link 100. An edge of the lock plate 111 also abuts an inner surface of the at least one catch wall 102.

In a preferred embodiment, the lock plate 111 is secured to each of the first 98 and second 100 links by the rivet 116, and a spring 114 is located on the rivet 116 which biases the lock plate 111 against the second link 100 so that the locking tab 112 is engaged under a side edge of the second link 100 in the first, extended position, preventing the links 98; 100 from folding up. In order to release the locking mechanism 110, the lock plate 111 is pushed sideways, compressing the spring 114, so that the locking tab 112 is disengaged from under the side edge of the second link 100. The links 98; 100 are then pivoted about the pivot points 104; 106 as the side frames 70; 80 are pivoted toward the top frame 58. Each of the locking corner braces 96 are preferably metal, but may be comprised of any suitable material.

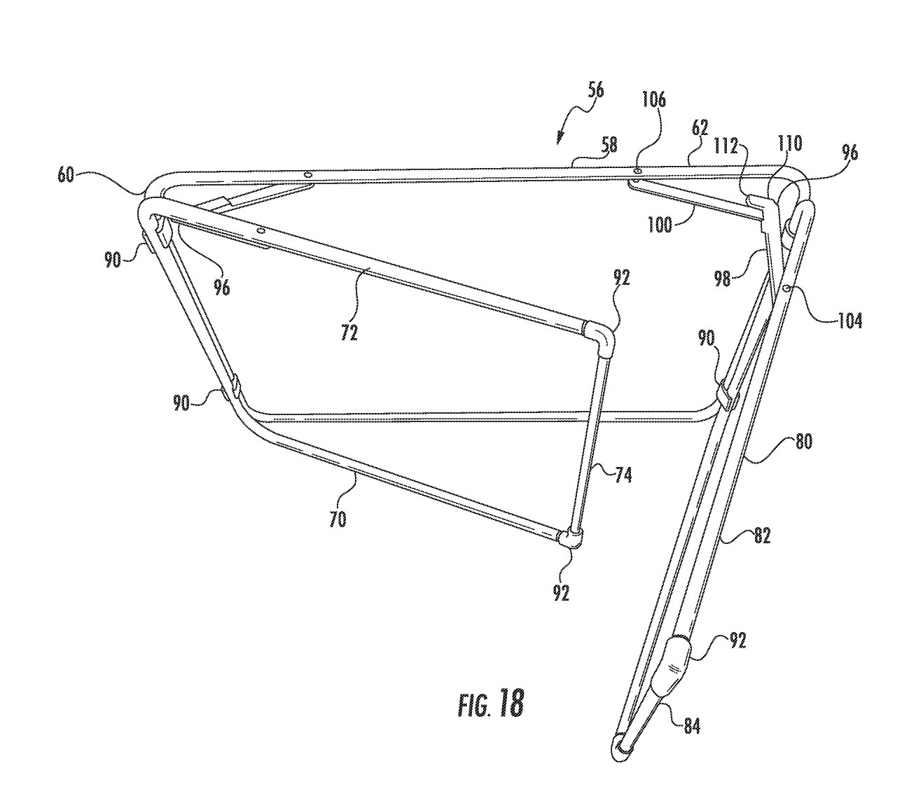

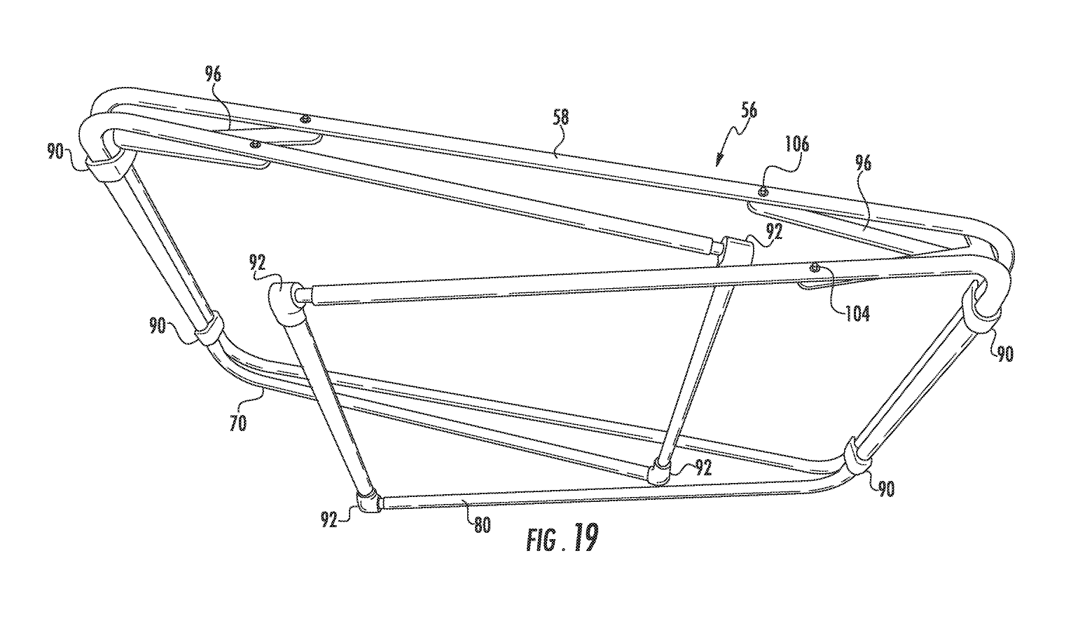

As shown in FIGS. 18 and 19, to fold the foldable soft pet crate 10 from a first, use position into a second collapsed position, after releasing the locking mechanism 110 from a locked position by flexing the locking tab 112 and the lock plate 111 against the force of the spring 114 out of engagement with the second link 100 of the locking corner braces 96, the user folds each of the side frames 70; 80 so that they extend generally parallel to the top frame 58. The side frames 70; 80 are pivoted via the pivot clamps 90 to the collapsed position. To move the foldable soft pet crate 10 into a first use position, the user unfolds each of the side frames 70; 80 so that they are generally parallel to each other and perpendicular to the top frame 58. The side frames 70; 80 are pivoted about the pivot clamps 90 to the extended position and are secured in place by the locking mechanism 110.

Because the foldable soft pet crate 10 does not have a rigid base or base frame, it is capable of folding more compactly than the foldable soft pet crates in the prior art. Additionally, this reduces costs and weight of the foldable soft pet crate 10, since the bottom of the pet crate is adapted to sit on the ground. There is no loss in functionality. A cushion or tray can still be loosely placed in the bottom of the foldable soft crate 10, if desired. Further, the front 28, side 30 and top 32 openings allow entry into the foldable soft pet crate 10 from multiple points allowing a pet to easily move in and out of the foldable soft pet crate 10 when the flaps are open.

In addition, in another embodiment (not shown) the foldable soft pet crate 10 may be comprised of accessories such as a partition fittable within the area in which the pet sits. The partition allows a user to separate this area, making the foldable soft pet crate 10 usable for multiple pets.

The foldable soft pet crate 10 can be made in different sizes to house different sized pets. A “small” sized foldable soft pet crate 10 may be 26.5″L×18″W×21″H to house a pet up to 30 lbs. A “medium” sized foldable soft pet crate 10 may be 36″L×24″W×27″H to house a pet up to 70 lbs. A “large” sized foldable soft pet crate 10 may be 42″L×29″W×28″H to house a pet up to 90 lbs. These are preferred dimensions but one of skill in the art would recognize that the foldable soft pet crate (10) may be made with different dimensions.

Having thus described in detail a preferred selection of embodiments of the present invention, it is to be appreciated and will be apparent to those skilled in the art that many physical changes could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A foldable soft crate, comprising:
a frame assembly including:
a top frame;
first and second side frames;
each of the side frames being pivotally connected to a respective opposite end of the top frame;
a first locking corner brace located between the top frame and the first side frame;
a second locking corner brace located between the top frame and the front side of the second side frame;
a cover including at least four flexible side panels and a bottom panel connected to each other and surrounding at least a portion of the frame assembly;
the top frame and the two side frames being movable upon release of the first and second locking corner braces from a first, extended position, where the two side frames are spaced apart from one another by a length of the top frame, to a second, collapsed position, where the locking corner braces are folded and the at least two side members are moved into proximity with one another and the top frame; and
only the side panels and bottom portions of the first and second side frames contact the bottom panel.

2. The foldable soft crate of claim 1, wherein the first locking corner brace is located between a front side of the top frame and a front side of the first side frame and the second locking corner brace is located between a front side of the top frame and a front side of the second side frame.

3. The foldable soft crate of claim 1, wherein the top frame comprises a first top member and a second top member.

4. The foldable soft crate of claim 3, wherein the first top member and second top member are U-shaped, the first top member being configured to be connected to the second top member so that the top frame is continuous.

5. The foldable soft crate of claim 1, wherein each of the two side frames have a U-shaped upper member and a base member connected to the upper member, the base member forming the bottom end of each respective one of the side frames.

6. The foldable soft crate of claim 5, wherein the upper member of each of the side frames is connected by a respective one of the locking corner braces to the top frame.

7. The foldable soft crate of claim 5, wherein the upper member is secured to the base member by corner parts.

8. The foldable soft crate of claim 1, wherein the locking corner braces have respective first and second links that are rotatable relative to each other; and
a locking mechanism is located between the first and second links and locks the links in an extended configuration when the frame is in the extended position.

9. The foldable soft crate of claim 8, wherein the locking mechanism has a locking tab that releases and secures the locking mechanism.

10. The foldable soft crate of claim 1, wherein each of the first and second locking corner braces each includes a first pivot point on a first end of the first link connected to the top frame, a second pivot point on a first end of the second link connected to the side frame, and a common third pivot point on a second end of each of the first and second links.

11. The foldable soft crate of claim 1, further comprising at least one opening in at least one of the at least four panels.

12. The foldable soft crate of claim 11, wherein the at least one opening comprises openings in a front panel, a side panel, and a top panel.

13. The foldable soft crate of claim 11, further comprising at least one flap that fits over the at least one opening.

14. The foldable soft crate of claim 1, wherein in the second collapsed position, each of the at least two side frames extend generally parallel to the top frame.

15. The foldable soft crate of claim 1, wherein in the first extended position, the at least two side frames are generally parallel to each other and perpendicular to the top frame.

16. A method of using a foldable soft crate, the method comprising:
providing a foldable soft crate, the crate including a frame assembly having a top frame and first and second side frames, each of the side frames being pivotally connected to a respective opposite end of the top frame, a first locking corner brace located between the top frame and the first side frame, a second locking corner brace located between the top frame and the second side frame, and a cover including at least four flexible side panels and a bottom panel connected to each other and surrounding a portion of the frame;
collapsing the crate by releasing the first and second locking corner braces from a first, extended position, to a second, collapsed position; and
drawing the two side frames towards the top frame.

17. The method of using the foldable soft crate of claim 16, further comprising:
a respective locking mechanism is located between a first and a second link of the first and second locking corner braces, and releasing the locking mechanism allows the first and second links to move from an extended, locked position to a collapsed position.
